(19) United States
(12) Patent Application Publication
(10) Pub. No.: US 2009/0316083 A1
(43) Pub. Date: Dec. 24, 2009

(54) Liquid Crystal Display Device and Manufacturing Method for Same

(76) Inventors: Atsushi KISHIOKA, Yokohama (JP); Shinji SEKIGUCHI, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/485,115

(22) Filed: Jun. 16, 2009

(30) Foreign Application Priority Data
Jun. 18, 2008 (JP) 2008-159236

(51) Int. Cl. G02F 1/1335

(52) U.S. Cl. 349/95; 349/187

(57) ABSTRACT

An object of the present invention is to provide a technology for stably forming condenser lenses in a liquid crystal display device having condenser lenses, in which the lenses are not affected by roughness and organic contamination on the surface of the substrate which may be caused by polishing and handling. The liquid crystal display device according to the present invention is provided with: a backlight module 510 for emitting light; a TFT substrate 507 provided on the backlight module 510 side; a color filter substrate 502 provided on the viewer side and a liquid crystal panel having a liquid crystal layer 504 provided between the TFT substrate and the color filter substrate; and a number of condenser lenses provided between the backlight module 510 and the liquid crystal panel. A transparent, flat layer 508 is formed on the outer surface of the TFT substrate 507 before forming the condenser lenses 509, and a number of condenser lenses 509 are formed on the transparent, flat layer 508. The transparent, flat layer 508 covers the recesses and protrusions on the surface of the TFT substrate 507, and therefore, condenser lenses 509 can be stably formed on the surface of the transparent, flat layer 508.

The present application claims priority over Japanese Application JP 2008-159236 filed on Jun. 18, 2008, the contents of which are hereby incorporated into this application by reference.

### BACKGROUND OF THE INVENTION

(1) Field of the Invention

The present invention relates to a liquid crystal display device having a built-in condenser lens.

(2) Related Art Statement

IPS (in-plane switching) and VA (vertical alignment) transmissive liquid crystal display devices having a wide view angle are currently widely in use for monitors for various apparatuses and televisions. In addition, liquid crystal display devices are widely used for portable information apparatuses, including portable phones and digital cameras, because they are light-weight. However, further reduction in the thickness and weight are required for display devices for portable information apparatuses, as portable information apparatuses are getting lighter. The thickness of most liquid crystal display devices for portable information apparatuses is reduced during the manufacturing process, by polishing the glass substrate of the liquid crystal panel. Methods for polishing glass substrates generally include chemical polishing using hydrofluoric acid or the like, and mechanical polishing for physically polishing using an abrasive.

In addition, display devices for portable information apparatuses are used in various environments in terms of the brightness, including outdoors in clear weather and in dark indoors. For this reason, transflective liquid crystal display devices having a reflective display portion and a transmissive display portion in each pixel have been developed. In transflective liquid crystal display devices, the transmissive display portions display an image using a backlight, as do conventional liquid crystal display panels, and the reflective display portions use reflection of external light for display. However, the backlight is blocked in the reflective display portions, and therefore, there is a problem, such that the numerical aperture is small in comparison with total transmissive liquid crystal display devices.

The resolution of liquid crystal display devices for portable information apparatuses has been increasing together with opportunities for one segment reception service for digital terrestrial broadcasting for portable phones and mobile terminals and high-resolution photography. There is a limit to the size of thin film transistors for driving liquid crystal and miniaturization of the width of wires, and the area of thin film transistor (TFT) substrates occupied by wires becomes larger as the resolution increases. Wires are formed of such materials as metals which do not transmit light, and therefore block the backlight. Therefore, the area of the aperture through which light transmits becomes smaller as the resolution increases.

As described above, the ratio of light from the backlight which transmits to the front of the display device tends to decrease in display devices for portable information apparatuses. As a method for avoiding this problem, there is a technology for forming condenser lenses on the outer surface of the TFT substrate so that light from the backlight is condensed in the aperture portion, and thus, light from the backlight which would otherwise be blocked by the outer surface of the TFT substrate and the reflective portion can be used effectively.

Patent Document 1 discloses a liquid crystal display device where a condenser plate having condenser lenses in a straight line is pasted to the liquid crystal panel on the backlight side so that light from the backlight is condensed into the aperture of the pixel electrodes. However, the condenser plate includes the thickness of the base of the condenser plate, not only of the condenser lens, and therefore, a method for forming only lenses directly on the liquid crystal panel is superior in order to reduce the thickness.

In addition, Patent Document 2 discloses a method for applying a photo curing resin film on a polarizing film, and after that transcribing the form of lenses onto the resin film by pressing a mold against it, and curing the resin film through exposure to light and baking, as well as a method for applying a transparent resin through an inkjet, as methods for forming a condenser lend array. However, polarizing films generally contract when heated, and therefore, the form and pitch of the lenses may change, due to the heat, when condenser lenses are formed on a polarizing film, which may affect the display performance. In addition, in many cases the distance between the condenser lens and the aperture portion is limited because of optical design, and the thickness of the polarizing film becomes a problem.

For the above reasons, condenser lenses may be formed directly on the outer surface of the liquid crystal panel, without a polarizing film in between. Various methods are known, as concerns technology for forming lenses directly on the panel, including the above described mold transcribing method and inkjet method, as well as printing methods, such as intaglio offset printing and methods combining photolithography and reflow.

[Patent Document 1] Japanese Unexamined Patent Publication 2003-337327

[Patent Document 2] Japanese Unexamined Patent Publication 2007-25109

### SUMMARY OF THE INVENTION

### Problem to Be Solved by the Invention

As described above, methods for shaving the glass substrate for a liquid crystal panel in order to reduce the thickness include chemical polishing and mechanical polishing. However, the surface of the substrate may be scratched and recesses (depressions) created, or there may be deposit, such as of silicon fluoride, when polished in accordance with these methods, and therefore, the surface of the glass may in many cases not be flat. When condenser lenses are formed directly on such a surface, the location where lenses are formed and the form of the lenses may become inconsistent. It becomes particularly difficult to form lenses stably with inkjet and intaglio offset printing methods, according to which lenses are formed by placing a material directly on the substrate and curing it.

Furthermore, in the case where condenser lenses are formed after a polarizing film is pasted on the outer surface of the substrate on the opposite side from where condenser lenses are formed, or after a driver IC is mounted, there is a possibility that the surface of the liquid crystal panel may be scratched or contaminated during handling, if it absorbs a foreign substance during the steps up to the formation of lenses, which makes stable formation of lenses more difficult.

The present invention provides a manufacturing process for stably forming condenser lenses, in which the lenses are not affected by roughness and organic contamination on the surface of the substrate which may be caused by polishing and handling as well as a structure for liquid crystal display devices.

### Means for Solving Problem

Typical inventions from among the inventions disclosed in the specification are briefly described below.

The manufacturing method for a liquid crystal display device according to the present invention is a manufacturing method for a liquid crystal display device having: an illumination apparatus for emitting light; a first substrate provided on the above described illumination apparatus side, a second substrate provided on the viewer side, and a liquid crystal panel having a liquid crystal layer provided between the above described first substrate and the above described second substrate; and a number of condenser lenses provided between the above described illumination apparatus and the above described liquid crystal panel, wherein the manufacturing method for a liquid crystal display device is characterized by including the steps of: forming a transparent, flat layer on an outer surface of the above described first substrate before forming the above described condenser lenses; and forming the above described number of condenser lenses on the above described transparent, flat layer.

The liquid crystal display device according to the present invention is a liquid crystal display device having: an illumination apparatus for emitting light; a first substrate provided on the above described illumination apparatus side, a second substrate provided on the viewer side, and a liquid crystal panel having a liquid crystal layer provided between the above described first substrate and the above described second substrate; and a number of condenser lenses provided between the above described illumination apparatus and the above described liquid crystal panel, wherein the liquid crystal display device is characterized by further having: a transparent, flat layer provided on the outer surface of the above described first substrate, and the above described number of condenser lenses on the above described transparent, flat layer.

### EFFECTS OF THE INVENTION

According to the present invention, a transparent, flat layer can be formed on the surface of a liquid crystal panel substrate on which deposit remains after polishing, or depressions or scratches remain, or there is organic contamination before the formation of condenser lenses, and thus, it becomes to stably form condenser lenses. Furthermore, a transparent, flat layer can be formed on a liquid crystal panel after mounting a driver IC or a flexible printed circuit board, thus making wet cleaning and surface polishing difficult, so that a uniform surface is easy to create. In addition, the layer thickness of the transparent, flat layer can be controlled, making it possible to control also the length of the light path.

### BRIEF DESCRIPTION OF THE DRAWINGS

FIG. 1 is a flow chart showing a process in which the manufacturing method for a liquid crystal display device according to the first embodiment of the present invention is applied;

FIG. 2 is a diagram showing the outer appearance of the liquid crystal display device for a portable apparatus according to the embodiment of the present invention as viewed from the top;

FIG. 3 is a cross sectional diagram along A-A′ in FIG. 2;

FIG. 4 is a schematic diagram showing an enlargement of the effective display region in FIG. 2;

FIG. 5 is a cross sectional diagram along B-B′ in FIG. 4 showing the first embodiment;

FIG. 6 is an exploded perspective diagram showing the effective display region in FIG. 2;

FIGS. 7A to 7E are schematic diagrams showing steps for forming a condenser lens 509 through intaglio offset printing;

FIG. 8 is a flow chart showing a process in the manufacturing method for a liquid crystal display device in which a modification of the first embodiment of the present invention is applied;

FIG. 9 is a flow chart showing a process in the manufacturing method for a liquid crystal display device in which the second embodiment of the present invention is applied;

FIG. 10 is a cross sectional diagram along B-B′ in FIG. 4 showing the second embodiment;

FIG. 11 is a bird's eye view showing the chemically polished glass surface as seen through an AFM;

FIG. 12 is a cross sectional diagram showing the surface of the substrate in FIG. 11;

FIG. 13 is a microscope photograph of the surface of a substrate where condenser lenses are formed directly on chemically polished glass through offset printing; and

FIG. 14 is microscope photograph showing the surface of a substrate where a transparent, flat layer is formed on chemically polished glass, and after that condenser lenses are formed through offset printing in accordance with the manufacturing method according to the first embodiment.

### EXPLANATION OF SYMBOLS

201 . . . effective display region
203 . . . driver IC
204 . . . flexible printed circuit board
303 . . . sealing material
401 . . . transmissive display portion
402 . . . signal line
403 . . . scan line
404 . . . reflective display portion
501 . . . polarizing film
502 . . . color filter substrate
503 . . . alignment film
504 . . . liquid crystal layer
507 . . . TFT substrate
508 . . . transparent, flat layer
509 . . . condenser lens
510 . . . backlight module
511 . . . adhesive layer of transparent, flat film
512 . . . base of transparent, flat film
601 . . . lens material
602 . . . intaglio plate
603 . . . transfer roller
604 . . . recess
605 . . . liquid crystal panel
607 . . . blanket

### DETAILED DESCRIPTION OF THE INVENTION

### Best Mode for Carrying Out the Invention

In the following, the embodiments of the present invention are described in detail.

### First Embodiment

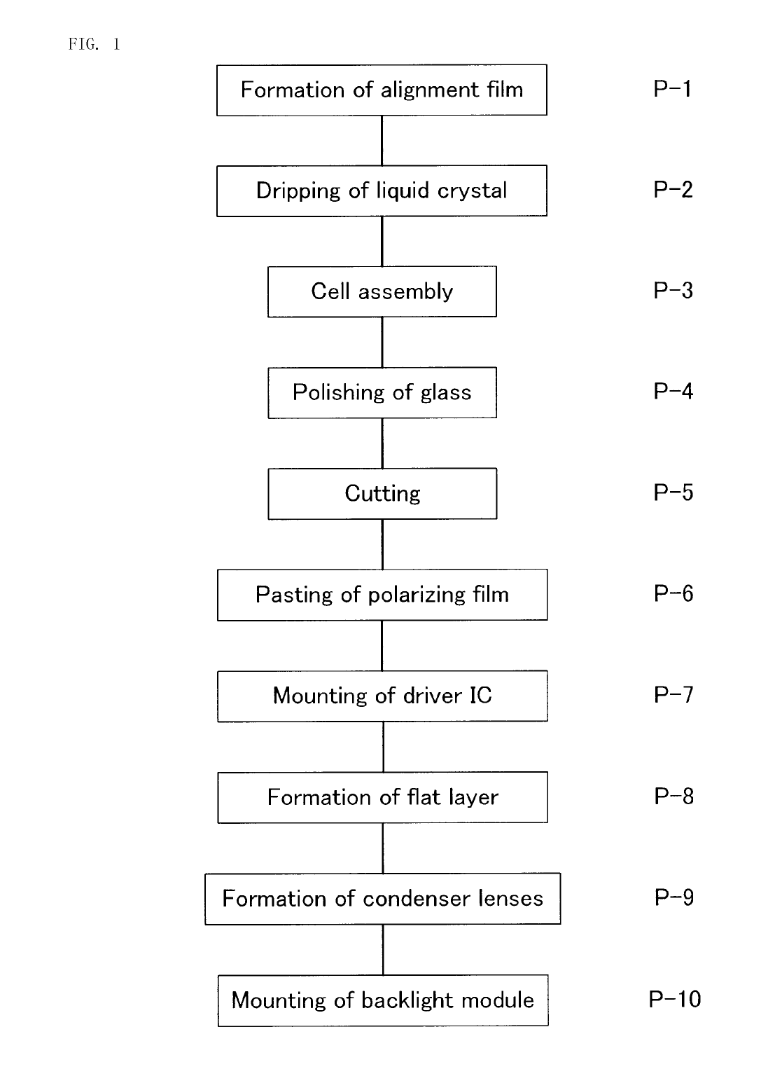

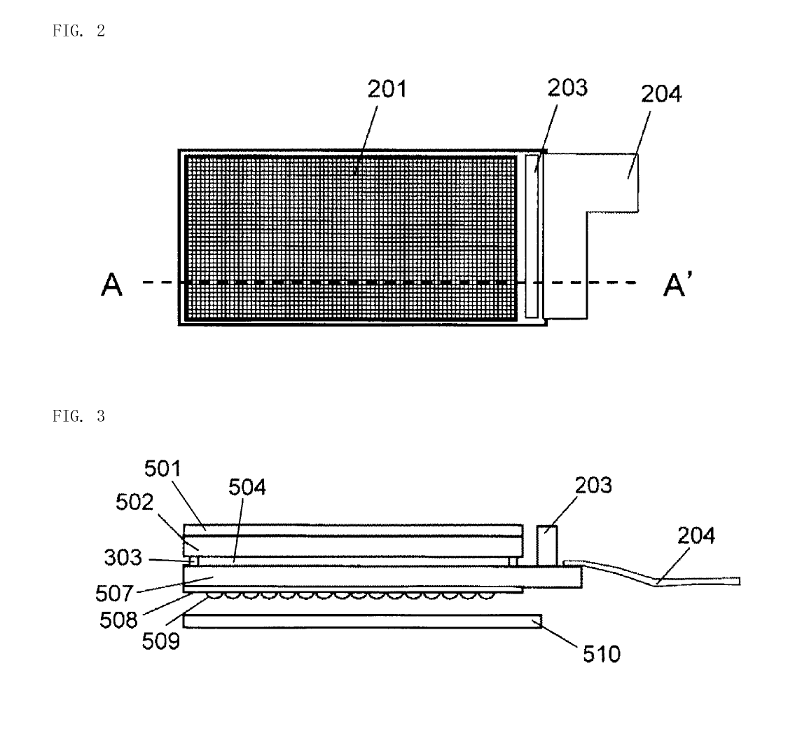

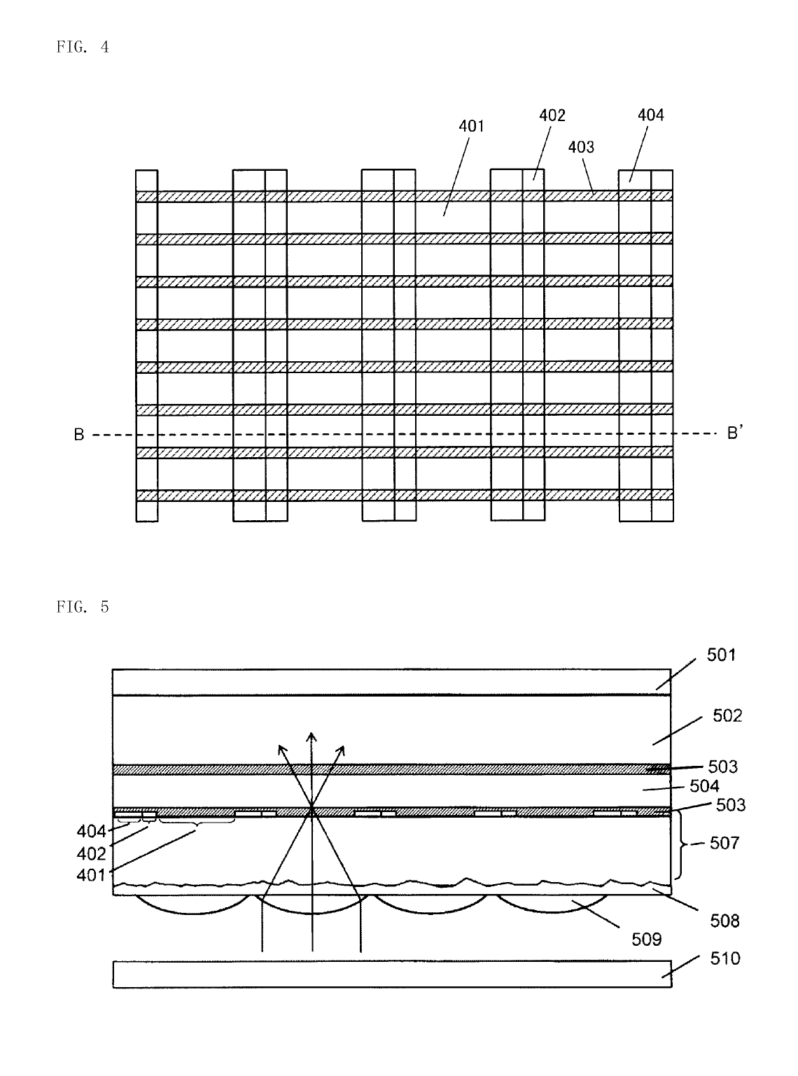

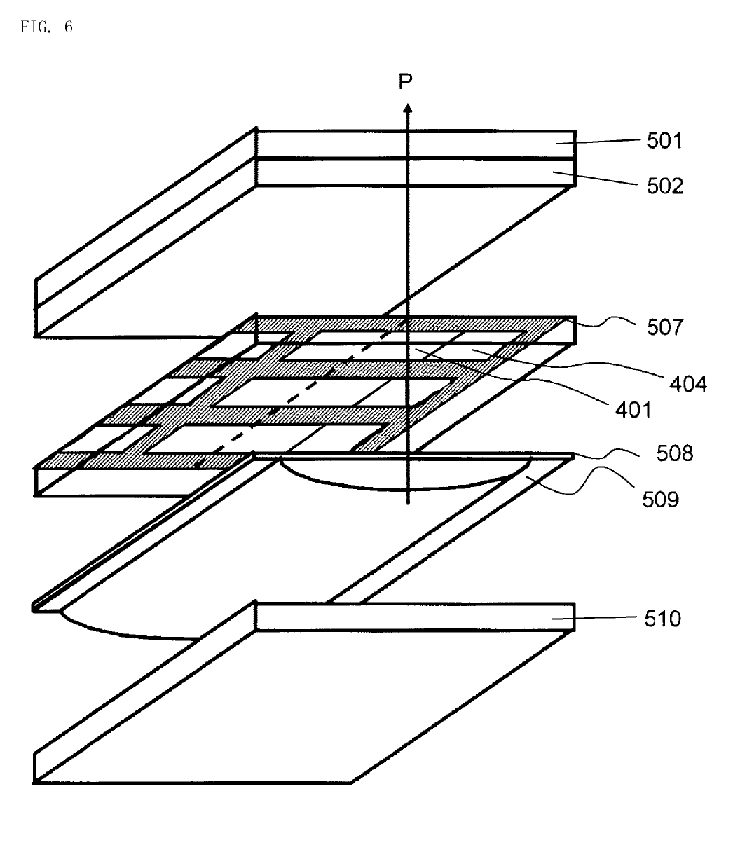

FIG. 1 is a flow chart showing a process in the manufacturing method for a liquid crystal display device according to the first embodiment of the present invention. FIG. 2 is a diagram showing the outer appearance of a transflective liquid crystal display device for a portable apparatus manufactured through the process in FIG. 1 as viewed from the top, and FIG. 3 is a cross sectional diagram along A-A′ in FIG. 2. FIG. 4 is a schematic diagram showing an enlargement of the effective display region 201 in FIG. 2, FIG. 5 is a cross sectional diagram along B-B′ in FIG. 4, and FIG. 6 is an exploded perspective diagram.

The manufacturing method for a liquid crystal display device according to the first embodiment of the present invention is described in reference to these drawings. First, an alignment film 503 which functions to align the liquid crystal layer 504 is formed on the main surface of the TFT substrate 507 and the color filter substrate 502 (P-1).

A wire layer is formed of scan lines 403 and signal lines 402 which cross on the TFT substrate 507. Pixel electrodes (not shown), which are transparent electrodes, are provided in pixel regions (sub-pixel regions) by dividing the matrix of scan lines 403 and signal lines 402. Each pixel electrode corresponds to one color resist (R (red), G (green) or B (blue)) on the color filter substrate 502 and forms a pixel region (sub-pixel region). Each pixel electrode is connected to a TFT (thin film transistor) formed in a portion where a scan line 403 and a signal line 402 cross, in a space between pixel electrodes (not shown). Scan lines 403 are connected to the gate electrode of the TFT's, and signal lines 402 are connected to the source/drain electrode of the TFT's. In addition, a reflective layer for reflecting external light is formed in the reflective display portion 404.

Color resists (R (red), G (green) or B (blue)) are provided in the divided pixel regions (sub-pixel regions) in a black matrix, so that color pixels are formed on the color filter substrate 502.

Here, in the present embodiment, a general multiple panel taking system is used in the liquid crystal panel mass production line, and thus, a large number of panels having a display effective surface can be arranged within the surface of a substrate, so that a number of liquid crystal panels can be mass produced from pairs of color filter substrates and TFT substrates.

In the step of forming an alignment film, a polyimide film is formed, and after that a rubbing process for rubbing the surface of the polyimide with a roller around which a cloth is wrapped carried out. Here, the alignment film may have a function of determining the initial alignment of the liquid crystal, and therefore, it is not necessary for the material to be polyimide, and as concerns the method for the alignment process, a method using energy, for example an ion beam or ultraviolet rays, or a method for structurally processing the surface may be used.

Next, a sealing material 303 is applied around the outer periphery of the effective pixel region on the surface of the color filter substrate 502 on which an alignment film 503 is formed, and an appropriate amount of liquid crystal is dropped in the effective pixel region on the color filter substrate 502 (P-2). A TFT substrate 507 is layered on top of this in such a manner that the alignment film 503 of the TFT substrate 507 faces the alignment film 503 of the color filter substrate 502 (P-3). In this step of sealing liquid crystal, a method referred to as “liquid crystal dripping method” is used, but the method is not limited to this, and a vacuum sealing method may be used.

After that, the outer surface of the TFT substrate 507 and the color filter substrate 502 is polished to a thickness of as little as 140 μm (P-4), and the substrates are cut into panels (P-5). A polarizing film 501 is pasted on the outer surface of the color filter substrate 502 (P-6). Next, a driver IC 203 and a flexible printed circuit board 204 are mounted on top (P-7). At this time, the outer surface of the TFT substrate has recesses in the glass, referred to as depressions, due to scratching during mechanical polishing, or chemical polishing, as well as protrusions, which are deposits of silicon fluoride and the like resulting from the step of polishing glass in P-4. In addition, the surface becomes scratched during handling in each step, or the surface may become contaminated with organic substances.

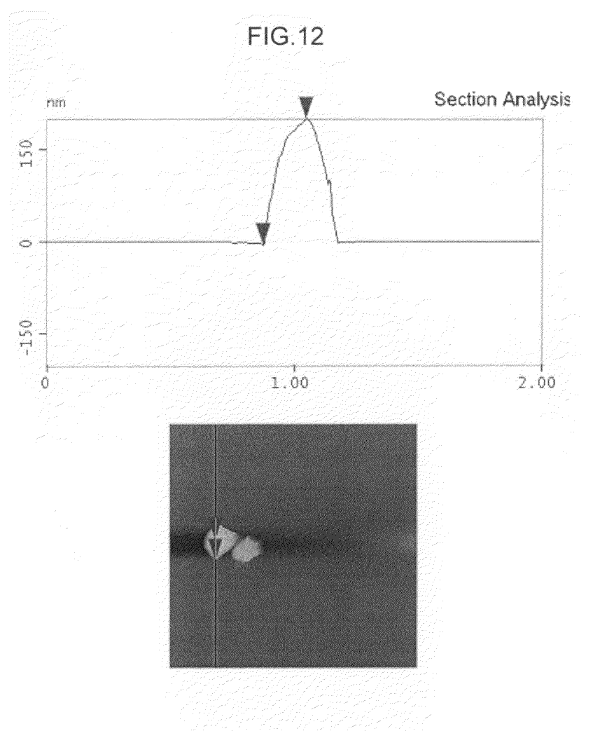

FIG. 11 is a bird's eye view of the chemically polished glass surface as seen through an AFM. The area shown in this bird's eye view is a square of 2 μm with an elevation of +/−45 nm. There are a large number of protrusions having a height of approximately 30 nm in the area shown in FIG. 11. Thus, a great number of protrusions which cannot be seen on the surface of conventional glass are observable on the chemically polished glass surface. These protrusions are considered to result from deposition of silicon fluoride during glass etching. In addition, the top diagram in FIG. 12 shows the cross section in another portion of the surface of the same substrate (cross sectional diagram along longitudinal line in bottom diagram). A protrusion having a height of more than 200 nm is also visible.

FIG. 5 schematically and clearly shows the roughness on the surface of the above described TFT substrate 507 resulting from glass polishing. This is different from the actual roughness in terms of size and form. In addition, the surface may also be rough on the color filter substrate 502 side, but this doesn't relate to the present embodiment, and therefore is not shown.

Wet cleaning and polishing are difficult on the surface of the substrate of a panel on which a driver IC, a flexible printed circuit board and the like are mounted, and therefore, the surface of the substrate can be cleaned only in accordance with a method for blowing away dust on the surface with air, a method for wiping the surface of the substrate with a cloth soaked with an organic solvent, or other, simple methods, such as excimer UV cleaning or plasma cleaning. In accordance with these methods, however, even in the case where the surface contaminated with foreign substances is cleaned, there are still recesses, protrusions and scratches on the surface, and therefore, in the case where lenses are formed on the surface, the form of the lenses becomes abnormal, and transfer becomes difficult.

In order to stably form lenses on an unclean and rough surface, a photocurable transparent resin is applied on the outer surface of the TFT substrate 507 using a slit coater, and irradiated with ultraviolet rays in a nitrogen atmosphere, and thus, a transparent, flat layer 508 is formed (P-8). Recesses and protrusions on the surface of the TFT substrate 507 are buried in this transparent, flat layer 508, and the surface of the transparent, flat layer 508 is flat. After that, condenser lenses 509 are formed on top of the transparent, flat layer 508 through intaglio offset printing (P-9). After that, a backlight module 510 is mounted on the condenser lens 509 side (P-10), and thus, a liquid crystal display device with a backlight is completed. The light emitted from this backlight module is polarized and collimated.

In the present embodiment, a material where a (meth)acryl monomer and a photoreaction initiator are mixed together is used, and the transparent, flat layer has a thickness of 10 μm, a transmittance of 98% or more and 100 or less for visible light (light having a wavelength of 400 nm to 800 nm), and an index of refraction of 1.5 after curing, but other light (ultraviolet ray) curing resin materials and thermocurable resin materials can be used as the material for the transparent, flat layer.

An acryl resin, an acryl epoxy resin, an acryl urethane resin, an acryl polyester resin, or an acryl silicon resin can be used as the photo curing resin, and a phenol resin, an epoxy resin, a urethane resin, a urea resin, a melamine resin, a silicon resin, an unsaturated polyester resin, a polyurethane resin, a polyimide resin or a fluorine resin can be used as the thermocurable resin. In addition, a phosphorous-doped silicate based resin, a methyl siloxane based resin or a high methyl siloxane based resin can also be used as the material. Here, a liquid crystal panel on which a driver IC is mounted is formed, and therefore, a photo curing resin is preferable, and these can be used alone or in combination.

(Meth)acrylate, for example 2-hydroxyethyl(meth)acrylate, glycidyl (meth)acrylate, bis glycidyl(meth)acrylate, dimethyl aminoethyl(meth)acrylate, polyethylene glycol di(meth)acrylate, trimethylol propane tri(meth)acrylate, lauryl (meth)acrylate, stearyl(meth)acrylate, benzyl(meth)acrylate, methyl(meth)acrylate, ethyl(meth)acrylate, propyl(meth)acrylate, butyl(meth)acrylate, hexyl(meth)acrylate, octyl(meth)acrylate and phosphorous containing (meth)acrylate, and N-cyclohexyl maleimide, N-2-methylhexyl maleimide, N-2-ethyl cyclohexyl maleimide, N-2-chlorocyclohexyl maleimide, N-phenyl maleimide, N-2-methylphenyl maleimide, N-2-ethylphenyl maleimide, N-2-chlorophenyl maleimide, dicyclopentenyl (meth)acrylate and dicyclopentenyl oxyethyl(meth)acrylate can be cited for the (meth)acryl monomer, which is a monomer having one photopolymerizing unsaturated bond per molecule.

In addition, (meth)acrylate, for example ethylene oxide (hereinafter referred to as “EO”) modified bisphenol A di(meth)acrylate, epichlorohydrin (hereinafter referred to as “ECH”) modified bisphenol A di(meth)acrylate, bisphenol A di(meth)acrylate, 1,4-butanediole di(meth)acrylate, 1,3-butylene glycol di(meth)acrylate, diethylene glycol di(meth)acrylate, glycerol di(meth)acrylate, neopentyl glycol di(meth)acrylate, EO modified di(meth)acrylate phosphate, ECH modified di(meth)acrylate phthalate, polyethylene glycol 400 di(meth)acrylate, polypropylene glycol 400 di(meth)acrylate, tetraethylene glycol di(meth)acrylate, ECH modified 1,6-hexanediole di(meth)acrylate, trimethylol propane tri(meth)acrylate, pentaerythritol tri(meth)acrylate, EO modified tri(meth)acrylate phosphate, EO modified trimethylol propane tri(meth)acrylate, propylene oxide (hereinafter referred to as “PO”) modified trimethylol propane tri(meth)acrylate, tris((meth)acryloxyethyl) isocyanurate, pentaerythritol tetra(meth)acrylate, dipentaerythritol tetra(meth)acrylate, dipentaerythritol hexa(meth)acrylate or dipentaerythritol penta(meth)acrylate, can be used as the monomer having two or more photopolymerizing unsaturated bonds per molecule. The above described (meth)acryl monomers can be used alone or in combination.

Furthermore, benzophenone, N,N′-tetraethyl-4,4′-diamino benzophenone, 4-methoxy-4′-dimethylamino benzophenone, benzyl, 2,2-diethoxyacetophenone, benzoin, benzoin methyl ether, benzoin isobutyl ether, benzyldimethyl ketal, α-hydroxyisobutyl phenone, thioxanthon, 2-chlorothioxanthon, 1-hydroxycyclohexyl phenyl ketone, 2-methyl-1-[4-(methylthio)phenyl]-2-morphorino-1-propane, t-butyl anthraquinone, 1-chloroanthraquinone, 2,3-dichloroanthraquinone, 3-chloro-2-methyl anthraquinone, 2-ethyl anthraquinone, 1,4-naphthoquinone, 9,10-phenanthraquinone, 1,2-benzoanthraquinone, 1,4-dimethyl anthraquinone, 2-phenyl anthraquinone, or dimeric 2-(o-chlorophenyl)-4,5-diphenyl imidazole can be used as the photoinitiator. These photoinitiators can be used alone or in combination.

In addition, cetyl alcohol, stearyl alcohol, oleyl alcohol, octyl alcohol, decyl alcohol, lauryl alcohol, tridecyl alcohol (tridecanol), n-butyl acohol, cyclohexyl alcohol, 2-methylcyclohexyl alcohol, or alkyl ether, for example methyl cellosolve, ethyl cellosolve, butyl cellosolve, butyl Carbitol, cellosolve acetate, butyl cellosolve acetate, Carbitol acetate or butyl Carbitol acetate, aromatic hydrocarbons, for example toluene, xylene or tetraphosphorous, or ketones, for example cyclohexanone, methyl cyclohexanone, isophoron or diacetone alcohol, can be used as the solvent, but the solvent is not limited to these, and any appropriate solvent may be selected taking the appropriateness for printing and ease of work into consideration. In addition, alcohol or an ester, for example butyl cellosolve, ethyl Carbitol, butyl cellosolve acetate, butyl Carbitol acetate or terpineol, may also be used.

In addition, an additive for increasing the wettability on the substrate, an additive for increasing the flatness, or an additive for adjusting the viscosity or thixotropic properties may be added.

Though in the present embodiment, a slit coater is used in the step of forming a flat layer, the flat layer may be formed in accordance with any method, for example through ink jetting, flexographic printing, screen printing or blade coating.

The liquid crystal display device according to the present embodiment is designed so that the distance between the condenser lenses and the transmissive apertures, which are the portions of the TFT substrate through which light transmits, is 150 μm, and when a liquid crystal panel is manufactured through the above described process, the thickness of the TFT substrate is 140 μm and the thickness of the flat layer is 10 μm, and thus, the total becomes 150 μm, which is the same as in the design. There is a certain minimum thickness for the substrate of liquid crystal panels which allows it to be stably mass produced, and currently it is generally difficult to mass produce liquid crystal panels where the substrate is polished to a thickness of 100 μm or less. Meanwhile, the polarizing film is as thick as approximately 100 μm, and therefore, in the case where the distance to the transmissive apertures is 150 μm, as in the present design, it is necessary to make the thickness of the glass substrate as thin as 50 μm, which is difficult, in order to use a method for forming condenser lenses on the polarizing film, where a polarizing film is pasted to the TFT substrate. In addition, polarizing films generally contract when heat is applied, and therefore, when condenser lenses are formed on the polarizing film, the pitch of the condenser lenses changes, as a result of the thermal contraction of the polarizing film. For the above reasons, it is difficult to provide a structure where condenser lenses are formed on a polarizing film in order to gain appropriate performance.

Therefore, it is necessary to form condenser lenses on the outer surface of TFT substrates having no polarizing film. However, the outer surface of the TFT substrate is not uniform during the above described step of forming condenser lenses, and the roughness and wettability on the surface vary, and therefore, it is difficult to stably form condenser lenses.

The surface can always be made uniform, without any difference in roughness and wettability, by forming a transparent, flat layer in accordance with the manufacturing method according to the present embodiment. In addition, the thickness of the flat layer can be adjusted when it is applied, and therefore, even in the case where the amount of glass being polished is inconsistent, the thickness of the flat layer can be adjusted so that the total thickness becomes constant, and thus, the distance between the condenser lenses and the transmissive apertures in the TFT substrate can be kept the same.

Though there are no problems when a thin layer (for example a monomolecular layer) is formed in order to make the wettability on the surface of the substrate uniform when condenser lenses are formed, it is necessary for the layer thickness to be 0.01 μm or more in order for there to be flattening effects. Though in many cases, a layer thickness of 0.01 μm is insufficient for making the entire surface of the substrate flat, the layer still has a certain degree of flattening effects on surfaces having great inconsistency due to protrusions resulting from deposition at the time of chemical polishing. In addition, when the flat layer has a thickness of approximately 10 μm, the flattening effects are more prevalent. In addition, the thickness of the transparent, flat layer is ideally determined taking the results of measurement for the coarseness on the surface and the thickness of the substrate into consideration.

When the liquid crystal display device is assembled, low transmittance of the flat layer may lead to loss of light if light from the backlight passes through the flat layer. In addition, in the case where the flat layer is colored, color reproduction may be poor in the liquid crystal display device. As a result, the higher the transmittance of the flat layer is for visible light, the better, and it is desirable for it to be 95% or higher.

In addition, the flat layer is formed on top of the recesses and protrusions on the TFT substrate, and therefore, light scatters when it passes through the interface between the substrate and the flat layer in the case where there is a big difference in the index of refraction between the substrate and the flat layer. Therefore, its is desirable for there to be little difference in the index of refraction between the substrate and the flat layer. Non-alkali glass is used for the substrate in general liquid crystal display devices having an index of refraction of approximately 1.5. Therefore, it is desirable for the index of refraction of the flat layer to be 1.3 to 1.7.

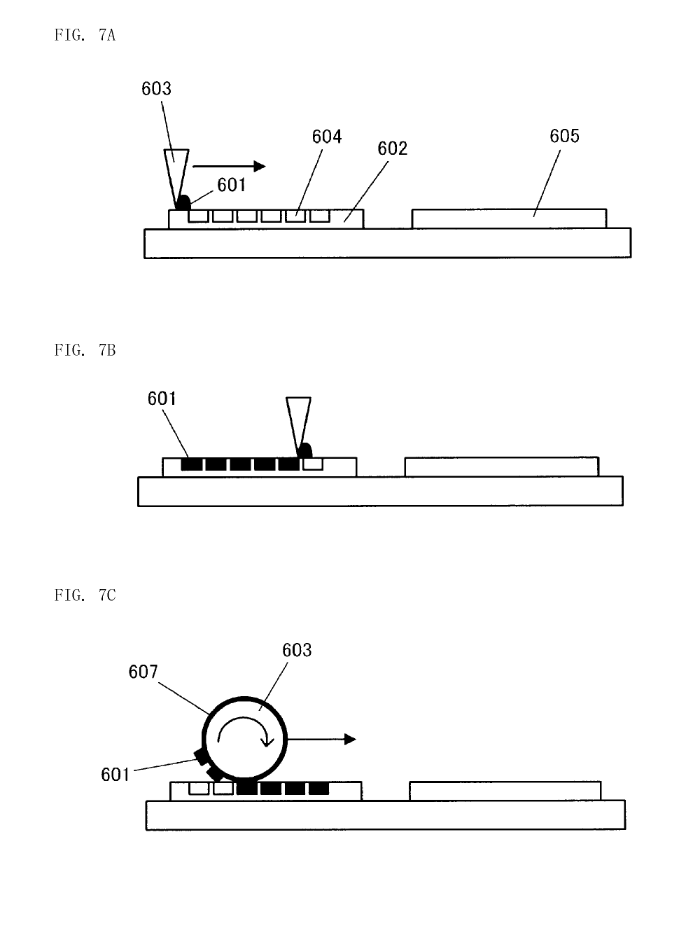

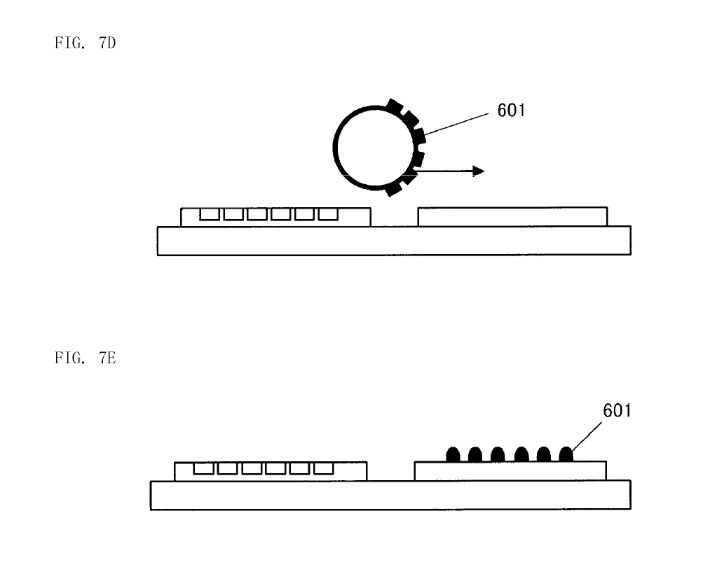

Here, the intaglio offset printing used in the method for forming condenser lenses according to the present embodiment is described. FIGS. 7A to 7E are schematic diagrams showing the steps for forming condenser lenses through intaglio offset printing (P-9). First, an intaglio 602 and a liquid crystal panel 605 are secured to the board of an offset printer. The liquid crystal panel 605 has a flat layer which is formed as described above (P-8), and the panel is secured with the transparent, flat layer 508 formed on the TFT substrate 507 as the top layer.

Recesses 604 corresponding to the pattern of condenser lenses 509 (lens pattern) are created in the intaglio 602. The depth and width of the recesses 604 are adjusted, and thus, the height and width of the formed lenses can be adjusted.

As shown in FIGS. 7A and 7B, a lens material 601 is put on top of the intaglio 602, and the lens material 601 is scraped flush with the surface of the intaglio using a doctor blade 603, so that the recesses 604 in the intaglio are filled in with the lens material 601. The lens material 601 may be the same photo (ultraviolet ray) curing polymer or thermocurable polymer as the above described transparent, flat layer.

Next, as shown in FIG. 7C, a transfer roller 603 having a blanket 607 around it is rolled over the intaglio 602 and, as shown in FIGS. 7C and 7D, the blanket 607 picks up the lens material 601. Furthermore, as shown in FIG. 7E, the transfer roller 603 is rolled over the upper surface of the liquid crystal panel 605, so that the lens material 601 picked up by the transfer roller 603 is transferred onto the liquid crystal panel 605. Here, the lens material 601 is curved in a cross section, due to the surface tension on the liquid crystal panel. This roundness makes the material work as a lens.

Finally, a process for irradiation using ultraviolet rays or heat treatment, or a combination of both, is carried out on the lens material 601 on the upper surface of the liquid crystal panel 605 in accordance with the material, so that the lens material 601 is cured. As a result, condenser lenses 509 having a predetermined pitch and height can be formed.

Here, printing may be carried out a number of times. For example, lenses may be formed on the upper surface of the liquid crystal panel 605 the first time, and other lenses formed between the lenses in the first pattern through offset printing. Thus, the density of lenses can be increased.

As for the method for forming condenser lenses, there are no limitations to the intaglio offset printing used in the present embodiment, and any technology for forming lenses directly on the surface of a substrate may be used, such as transfer methods using a die, as that described above, inkjet methods, or methods combining photolithography and reflow, can be used.

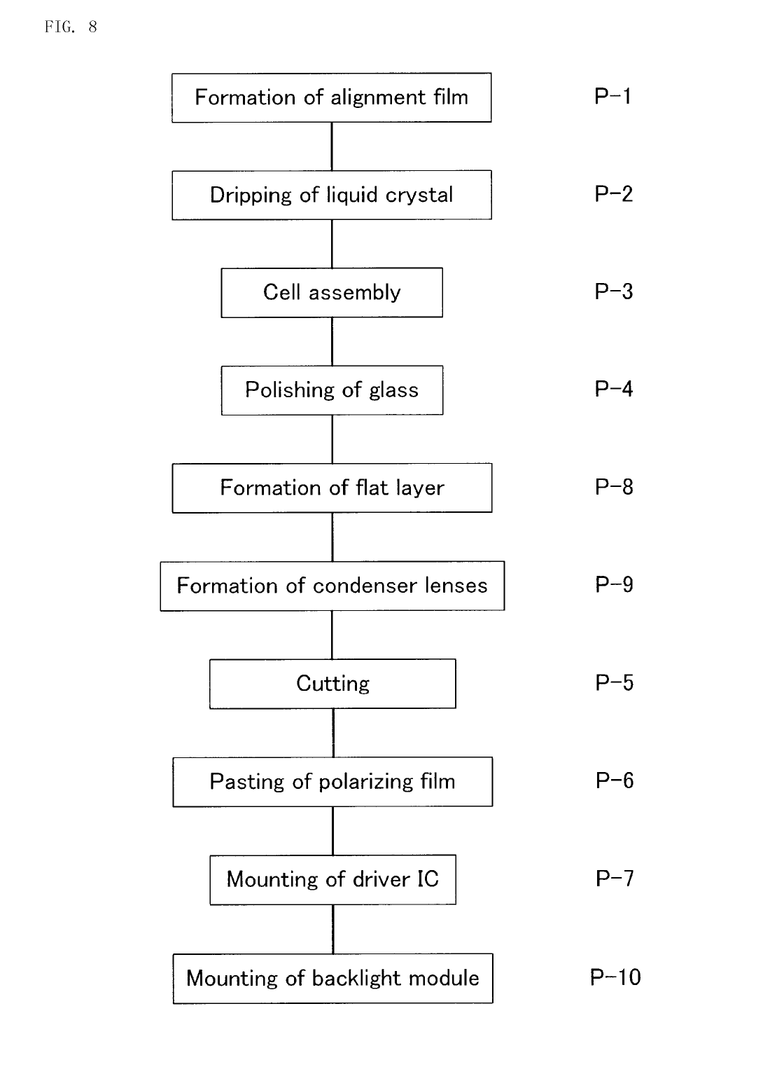

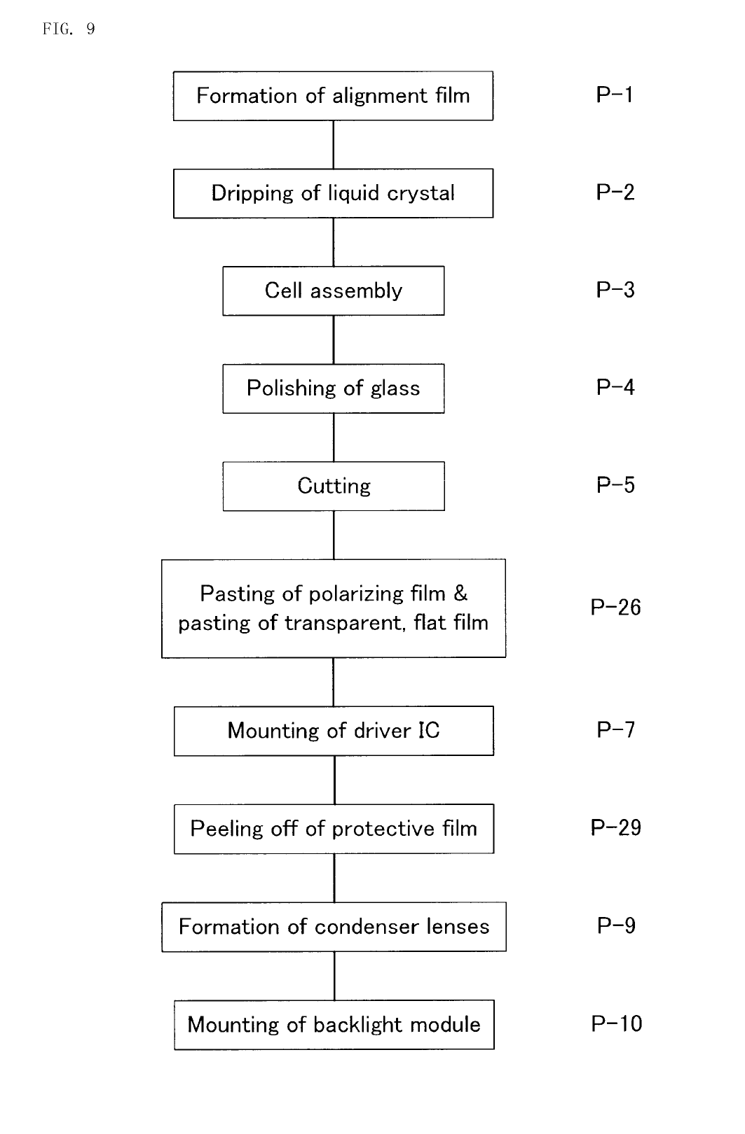

As shown in FIG. 8, the steps for forming a flat layer and condenser lenses can be carried out after the step of polishing the glass (P-4) and before the step of cutting the glass (P-5). In addition, the process is not limited to this, and these steps may be carried out anytime after the step of polishing the glass (P-4) and before the step of mounting a backlight module (P-10), as long as the condenser lenses are formed after the flat layer, and there may be another step between the formation of a flat layer and the formation of condenser lenses. Here, it is more effective to form a flat layer immediately before the condenser lenses, taking the cleanliness on the surface of the substrate when condenser lenses are formed into consideration.

Here, the configuration of the liquid crystal panel manufactured in accordance with the manufacturing method of the present embodiment is described in reference to FIGS. 5 and 6. Condenser lenses 509 are provided in order to condense light from the backlight module 510 into transmissive display portions 401, which are transmissive apertures in the TFT substrate 507. The condenser lenses 509 are a number of cylindrical lenses which protrude toward the backlight.

As shown in FIG. 6, cylindrical lenses that form the condenser lenses 509 are provided so that the direction of the length of the cylinders coincides with the direction of the short side of the rectangular sub-pixels. In addition, one cylindrical lens is provided per column in the direction of the short side in the pixel regions. That is to say, the center of the protrusions of the cylinders coincides with the center line of the pixel columns, as shown by the arrow P in the figure. In the case where the lenses have an appropriate form, so that the center of the protrusions of the cylinders coincides with the center line of the transmissive display portion, light which would otherwise enter the reflective display portion 404 and wire portions can be condensed in transmissive display portions. Thus, the backlight can bee used effectively.

Here, there are no limitations to the form of the condenser lenses 509, and the lenses are not limited to being cylindrical, as long as they efficiently condense light in transmissive regions. Any form that allows light from the backlight to be guided to the light transmitting portions is possible, and spherical lenses and concave lenses may be used, for example, and in addition, the arrangement of the lenses is not limited to the above, and any arrangement is possible, as long as it has satisfactory performance.

As described above, a liquid crystal display device with high definition where light from the backlight can be sufficiently and effectively used can be gained at low cost and with high yield.

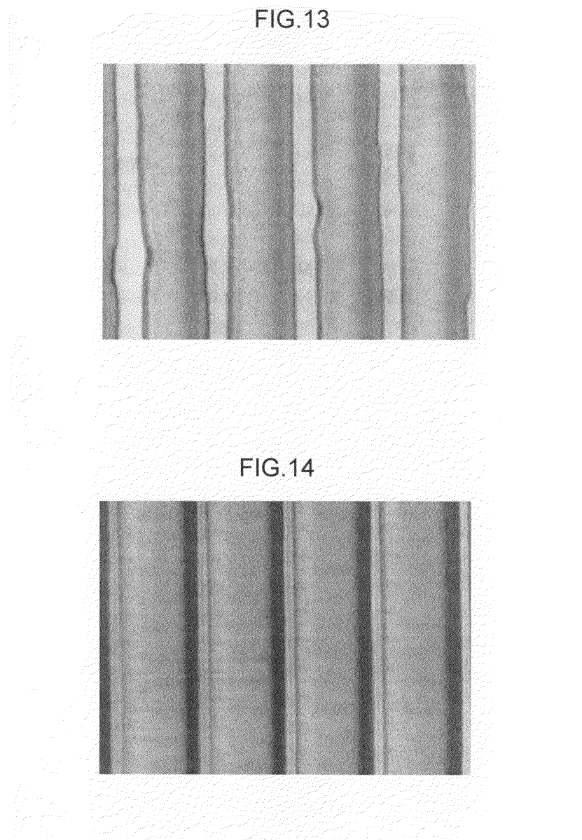

In accordance with the manufacturing method for a liquid crystal display device of the present embodiment, the recesses and protrusions on the surface of the TFT substrate 507 are buried in the transparent, flat layer 508, and therefore, stable condenser lenses 509 can be formed on the surface of the transparent, flat layer 508. FIG. 13 is a microscope photograph of the surface of the chemically polished glass substrate on which condenser lenses are directly formed through offset printing. It can be seen in FIG. 13 that the edges of the cylindrical lenses are inconsistent. FIG. 14 is a microscope photograph of the surface of the chemically polished glass substrate on which a flat layer is formed in accordance with the manufacturing method of the present embodiment, and condenser lenses are formed through offset printing. It can be seen that ideal cylindrical lenses could be formed in the present embodiment (FIG. 14), as opposed to in the case where condenser lenses are formed directly on the substrate (FIG. 13).

Though in the present embodiment, a manufacturing method for a liquid crystal display device for a portable apparatus is described, the present embodiment can be applied to transmissive liquid crystal display devices having no reflective display portion 404, as well as to liquid crystal panels for applications other than portable apparatuses, such as televisions and car navigation. In addition, the present embodiment can be applied to various liquid crystal devices, for example to TN (twisted nematic) devices, IPS (in-place switching) devices, or VA (vertical alignment) devices. In the case of other devices, the configuration of the elements, the form of the elements, the manufacturing method and the materials may be completely different. However, whatever the type of device, the effects of the manufacturing method of the present embodiment can be gained for any device, so that scratching, deposition and contamination on the surface of the substrate caused during polishing of the substrate or handling can be prevented from becoming a problem, by forming a transparent, flat layer on the outer surface of the substrate before the condenser lenses.

### Second Embodiment

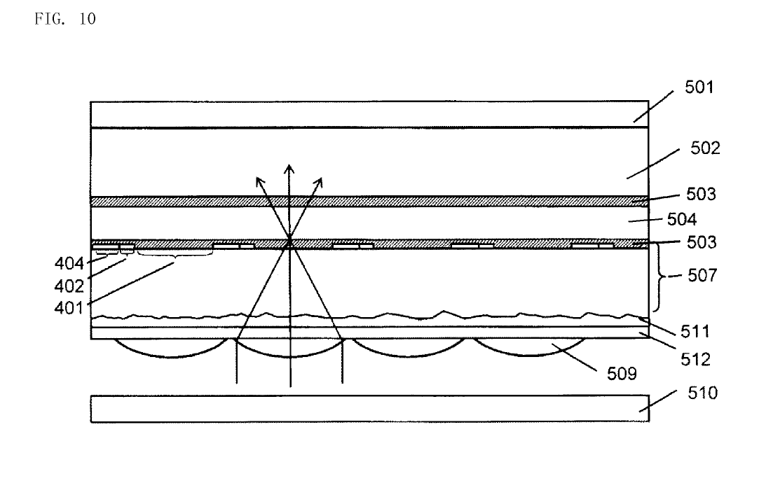

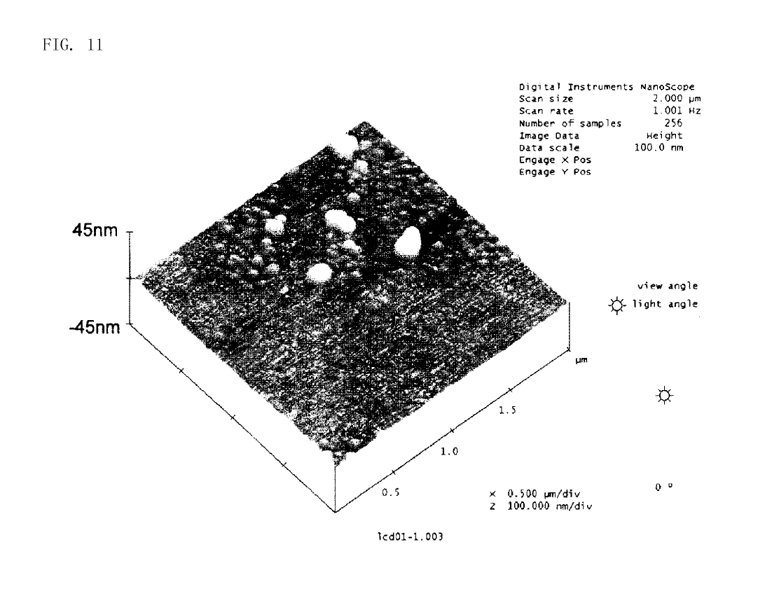

FIG. 9 is a flow chart showing the process in accordance with the manufacturing method for a liquid crystal display device according to the second embodiment of the present invention. The final structure of the liquid crystal display device manufactured through the present process is the same as in the first embodiment, except that a transparent, flat film is used for the flat layer. FIG. 2 is a schematic diagram showing the outer appearance of a transflective liquid crystal display device for a portable apparatus manufactured through the process in FIG. 9 as viewed from the top, and FIG. 3 is a cross sectional diagram along A-A′ in FIG. 2. FIG. 4 is a schematic diagram showing an enlargement of the effective display region 201 in FIG. 2, FIG. 10 is a cross sectional diagram along B-B′ in FIG. 4, and FIG. 6 is an exploded perspective diagram.

As concerns the process, the steps up to the step of layering the TFT substrate 507 and the color filter substrate 502 on top of each other and sealing in the liquid crystal (P-3) are the same as in the first embodiment, and therefore, only the remainder of the process is described below.

The outer surface of both the TFT substrate 507 and the color filter substrate 502 which overlap is polished to a thickness of 100 μm (P-4), and the substrates are cut into panels (P-5).

As described in the first embodiment, at this time, the outer surface of the TFT substrate has scratches which come about during mechanical polishing, recesses in the glass, referred to as depressions, resulting from chemical polishing, and protrusions made of silicon fluoride deposit, which are created in the process of polishing glass in P-4. In addition, the surface of the substrate may be scratched during handling, or contaminated with organic substances, in any of the steps. In FIG. 10, the coarseness on the surface of the TFT substrate 507 resulting from glass polishing is exaggerated, and thus different from the actual size and form. In addition, though the color filter substrate 502 side may have the same coarseness on the surface, this does not relate to the present embodiment, and therefore is not shown.

After that, a polarizing film 501 is pasted on the outer surface of the color filter substrate 502. At the same time, or before or after, a transparent, flat film is pasted on the outer surface of the TFT substrate 507 (P-26). This transparent, flat film has three layers: an adhesive layer, a base and a protective film, in this order, so that it adheres to the TFT substrate. The index of refraction of the adhesive layer and the base is 1.5, and the total thickness of the base and the adhesive layer in the transparent, flat film is 50 μm. In addition, the transmittance of the transparent, flat film for visible light (having a wavelength of 400 nm to 800 nm) after being pasted to the TFT substrate is 95% or more and 100% or less.

Next, a driver IC 203 and a flexible printed circuit board 204 are mounted on the substrate (P-7). After that, the protective film which is pasted on the transparent, flat film in P-26 is peeled off (P-29), and condenser lenses 509 are formed through intaglio offset printing (P-9). After that, a backlight module 510 is mounted on the condenser lens 509 side (P-10), and thus, a liquid crystal display device with a backlight is completed. Light emitted from the backlight module is polarized and collimated.

The protective film is provided on the transparent, flat film in order to prevent the transparent, flat film from being scratched during handling, or when a panel is secured in the steps up to the formation of condenser lenses, after the transparent, flat film is pasted.

FIG. 10 shows the transparent, flat film after the formation of condenser lenses 509, where the transparent, flat film is pasted to the TFT substrate 507, from which the protective film for the transparent, flat film is peeled off. 512 is the base of the transparent, flat film, and 511 is an adhesive layer or the transparent, flat film. As shown in FIG. 10, recesses and protrusions on the surface of the TFT substrate 507 are buried in the adhesive layer 511 of the transparent, flat film, so that the surface of the base 512 of the transparent, flat film is flat, and condenser lenses 509 are formed on the surface of the base 512 of the transparent, flat film.

The adhesive layer 511 is formed in order to bury the recesses and protrusions on the TFT substrate, and therefore, in the case where there is a great difference in the index of refraction between the substrate and the adhesive layer, light scatters when passing through the interface between the two. Therefore, it is desirable for there to be little difference in the index of refraction between the substrate and the adhesive layer. Non-alkali glass is used for the substrate of general liquid crystal display devices, and the index of refraction thereof is approximately 1.5. Therefore, it is desirable for the index of refraction of the adhesive layer to be 1.3 to 1.7. In addition, it is preferable for there to be little difference in the index of refraction between the base 512 and the adhesive layer 511 in the transparent, flat film, and it is better for there to be little optical anisotropy.

When a liquid crystal display device is assembled, light from the backlight transmits through the base 512 and the adhesive layer 511 in the transparent, flat film, and therefore, there is loss of light in the base and the adhesive layer in the transparent, flat film if the transmittance is low. In addition, the color reproducibility of the liquid crystal display device becomes poor in the case where the base and the adhesive layer in the transparent, flat film are colored. Therefore, the higher the transmittance of the base and the adhesive layer in the transparent, flat film is for visible light, the better, and it is desirable for the transmittance to be 95% or higher.

In addition, though the transparent, flat film has a three-layer structure, it may have more than three layers, or formed of two layers: an adhesive layer cured using light or heat, and a protective film. In addition, since there is no protective film in the final liquid crystal panel, there are no limitations to the quality of the material in terms of transparency and thickness. In addition, it is not necessary to provide a protective film in the case where the surface of the film is hard and difficult to contaminate.

The liquid crystal display device of the present embodiment is designed so that the distance between the condenser lenses and the transmissive apertures, which are light transmitting portions in the TFT substrate, is 150 μm, and therefore, liquid crystal panels manufactured through the above described process have a thickness of 150 μm, which is the sum of the thickness of the TFT substrate (100 μm) and the total thickness of the base and the adhesive layer in the transparent, flat film (50 μm), which matches the design.

As described above, the polarizing film contracts when heated, and therefore, the pitch of the condenser lenses changes, as a result of the thermal contraction of the polarizing film, after condenser lenses are formed on the polarizing film. However, a transparent, flat film which does not easily thermally expand or shrink is selected for the present embodiment, and thus, the pitch of the lenses changes less due to heat, in comparison with the case where the condenser lenses are formed on a polarizing film.

In addition, a transparent, flat film is provided and the protective film peeled off immediately before condenser lenses are formed without the quality being affected by the roughness and inconsistent wettability on the surface, and thus, the surface can always be made uniform when forming lenses.

As in the present embodiment, it is better to provide a transparent, flat film in the same step as the polarizing film, from the point of view of the manufacture, and it is highly effective to peel the protective film directly before forming condenser lenses, because a clean surface can be maintained. However, the transparent, flat film may be provided anytime after the glass is polished (P-4) and before the formation of condenser lenses (P-9), and the protective film may be peeled off anytime after the transparent, flat film is provided and before the formation of condenser lenses.

As described above, the surface is uniform when the lenses are formed, and therefore, a liquid crystal display device where light from the backlight can be effectively used can be gained with high precision and high yield at low cost.

In accordance with the manufacturing method for a liquid crystal display device of the present embodiment, recesses and protrusions on the surface of the TFT substrate 507 are buried in the adhesive layer 511 in the transparent, flat film, and therefore, stable condenser lenses 509 can be formed on the surface of the base 512 of the transparent, flat film.

Though in the present embodiment, a manufacturing method for a liquid crystal display device for a portable apparatus is described, the present embodiment can be applied to transmissive liquid crystal display devices having no reflective display portion 404, as well as to liquid crystal panels for applications other than portable apparatuses, such as televisions and car navigation. In addition, the present embodiment can be applied to various liquid crystal devices, for example to TN (twisted nematic) devices, IPS (in-place switching) devices, or VA (vertical alignment) devices. In the case of other devices, the configuration of the elements, the form of the elements, the manufacturing method and the materials may be completely different. However, whatever the type of device, the effects of the manufacturing method of the present embodiment can be gained for any device, so that scratching, deposition and contamination on the surface of the substrate caused during polishing of the substrate or handling can be prevented from becoming a problem, by forming a transparent, flat layer on the outer surface of the substrate before the condenser lenses.

### Third Embodiment

The third embodiment is a transflective liquid crystal display device for a portable apparatus manufactured in accordance with the manufacturing method of the first embodiment. FIG. 2 is a schematic diagram showing the outer appearance of a transflective liquid crystal display device for a portable apparatus manufactured in accordance with the manufacturing method of the first embodiment as viewed from the top, and FIG. 3 is a cross sectional diagram along A-A′ in FIG. 2. FIG. 4 is a schematic diagram showing an enlargement of the effective display region 201 in FIG. 2, FIG. 5 is a cross sectional diagram along B-B′ in FIG. 4, and FIG. 6 is an exploded perspective diagram. The liquid crystal display device according to the third embodiment of the present invention is described below in reference to these drawings.

Alignment films 503 which function to align the liquid crystal layer 504 are formed on the main surface of the TFT substrate 507 and the color filter substrate 502. A sealing material 303 is formed around the outer periphery of the effective pixel region, and a liquid crystal layer 504 is sealed inside.

A wire layer made up of scan lines 403 and signal lines 402 which cross is formed on the TFT substrate 507. Pixel electrodes (not shown), which are transparent electrodes, are provided in pixel regions (sub-pixel regions) by dividing the matrix of scan lines 403 and signal lines 402. The pixel electrodes each correspond to one of the color resists (R (red), G (green) or B (blue)) on the color filter substrate 502, and become pixel regions (sub-pixel regions). The respective pixel electrodes are connected to TFT's (thin film transistor) formed in portions where the scan lines 403 and the signal lines 402 cross between pixel electrodes (not shown). The scan lines 403 are connected to the gate electrode of the TFT's, and the signal lines 402 are connected to the source/drain electrode of the TFT's. In addition, an external light reflecting layer for reflecting external light is formed in the reflective display portion 404.

Color resists (R (red), G (green) and B (blue)) are aligned in pixel regions (sub-pixel regions) provided by dividing the color filter substrate 502 having a black matrix, and thus, color pixels are formed.

A polarizing film is pasted on the outer surface of the color filter, and a driver IC 203 and a flexible printed circuit board 204 are mounted on the TFT substrate. In addition, a transparent, flat layer 508 is provided on the outer surface of the TFT substrate 507, and condenser lenses are formed on the surface of this transparent, flat layer. In addition, a backlight module 510 is mounted on the condenser lens 509 side, and light emitted from this backlight module is polarized and collimated.

The condenser lenses 509 are provided so as to condense light from the backlight module 510 into the transparent display portions 401, which are transmissive apertures in the TFT substrate 507. The condenser lenses 509 are a number of cylindrical lenses which protrude toward the backlight.

As shown in FIG. 6, cylindrical lenses that form the condenser lenses 509 are provided so that the direction of the length of the cylinders coincides with the direction of the short side of the rectangular sub-pixels. In addition, one cylindrical lens is provided per column in the direction of the short side in the pixel regions. That is to say, the center of the protrusions of the cylinders coincides with the center line of the pixel columns, as shown by the arrow P in the figure. In the case where the lenses have an appropriate form, so that the center of the protrusions of the cylinders coincides with the center line of the transmissive display portion, light which would otherwise enter the reflective display portion 404 and wire portions can be condensed in transmissive display portions. Thus, the backlight can bee used effectively.

Here, there are no limitations to the form of the condenser lenses 509, and the lenses are not limited to being cylindrical, as long as they efficiently condense light in transmissive regions. Any form that allows light from the backlight to be guided to the light transmitting portions is possible, and spherical lenses and concave lenses may be used, for example, and in addition, the arrangement of the lenses is not limited to the above, and any arrangement is possible, as long as it has satisfactory performance.

The transparent, flat layer 508 is made of a photo (ultraviolet ray) curing resin material or a thermocurable resin material. An acryl resin, an acryl epoxy resin, an acryl urethane resin, an acryl polyester resin, or an acryl silicon resin can be used as the photo curing resin, and a phenol resin, an epoxy resin, a urethane resin, a urea resin, a melamine resin, a silicon resin, an unsaturated polyester resin, a polyurethane resin, a polyimide resin or a fluorine resin can be used as the thermocurable resin. In addition, a phosphorous-doped silicate based resin, a methyl siloxane based resin or a high methyl siloxane based resin can also be used as the material.

The liquid crystal display device according to the present embodiment is designed so that the distance between the condenser lenses and the transmissive apertures, which are the portions of the TFT substrate through which light transmits, is 150 μm, and in the liquid crystal display device according to the present embodiment, the thickness of the TFT substrate is 140 μm and the thickness of the flat layer is 10 μm, and thus, the total becomes 150 μm, which is the same as in the design. There is a certain minimum thickness for the substrate of liquid crystal panels which allows it to be stably mass produced, and currently it is generally difficult to mass produce liquid crystal panels where the substrate is polished to a thickness of 100 μm or less. Meanwhile, the polarizing film is as thick as approximately 100 μm, and therefore, in the case where the distance to the transmissive apertures is 150 μm, as in the present design, it is necessary to make the thickness of the glass substrate as thin as 50 μm, which is difficult, in order to use a structure where condenser lenses are mounted on the polarizing film on the TFT substrate. In addition, polarizing films generally contract when heat is applied, and therefore, the pitch of the condenser lenses changes in the condenser lenses on the polarizing film, as a result of the thermal contraction of the polarizing film. For the above reasons, it is difficult to provide a structure where condenser lenses are formed on a polarizing film in order to gain appropriate performance.

Therefore, it is necessary to mount condenser lenses on the outer surface of TFT substrates having no polarizing film. However, the outer surface of the TFT substrate is not uniform during the above described step of forming condenser lenses, and the roughness and wettability on the surface vary, and therefore, it is difficult to stably mount condenser lenses.

The surface can always be made uniform, without any difference in roughness and wettability, in the transparent, flat layer of the present embodiment. In addition, the thickness of the flat layer can be adjusted when it is applied, and therefore, even in the case where the amount of glass being polished is inconsistent, the thickness of the flat layer can be adjusted so that the total thickness becomes constant, and thus, a structure where the distance between the condenser lenses and the transmissive apertures in the TFT substrate can be kept the same can be gained.

Though there are no problems with thin layer (for example monomolecular layer) in order to make the wettability on the surface of the substrate uniform when condenser lenses are formed, it is necessary for the layer thickness to be 0.01 μm or more in order for there to be flattening effects. Though in many cases, a layer thickness of 0.01 μm is insufficient for making the entire surface of the substrate flat, the layer still has a certain degree of flattening effects on surfaces having great inconsistency due to protrusions resulting from deposition at the time of chemical polishing. In addition, when the flat layer has a thickness of approximately 10 μm, the flattening effects are more prevalent.

In addition, low transmittance of the flat layer may lead to loss of light if light from the backlight passes through the flat layer. In addition, in the case where the flat layer is colored, color reproduction may be poor in the liquid crystal display device. As a result, the higher the transmittance of the flat layer is for visible light, the better, and it is desirable for it to be 95% or higher.

In addition, the flat layer is formed on top of the recesses and protrusions on the TFT substrate, and therefore, light scatters when it passes through the interface between the substrate and the flat layer in the case where there is a big difference in the index of refraction between the substrate and the flat layer. Therefore, its is desirable for there to be little difference in the index of refraction between the substrate and the flat layer. Non-alkali glass is used for the substrate in general liquid crystal display devices having an index of refraction of approximately 1.5. Therefore, it is desirable for the index of refraction of the flat layer to be 1.3 to 1.7.

As described above, the present structure can provide a uniform surface when lenses are formed, and therefore, a high-definition liquid crystal display device which can sufficiently and effectively use light from the backlight can be gained at low cost and with high yield.

In the liquid crystal display device according to the present embodiment, recesses and protrusions on the surface of the TFT substrate 507 are buried in the transparent, flat layer 508, and therefore, stable condenser lenses 509 can be formed on the surface of the transparent, flat layer 508, so that the condenser lenses 509 can appropriately condense light from the backlight module 510.

Though in the present embodiment, a liquid crystal display device for a portable apparatus is described, the present embodiment can be applied to transmissive liquid crystal display devices having no reflective display portion 404, as well as to liquid crystal panels for applications other than portable apparatuses, such as televisions and car navigation. In addition, the present embodiment can be applied to various liquid crystal devices, for example to TN (twisted nematic) devices, IPS (in-place switching) devices, or VA (vertical alignment) devices. In the case of other devices, the configuration of the elements, the form of the elements, the manufacturing method and the materials may be completely different. However, whatever the type of device, the effects of the manufacturing method of the present embodiment can be gained for any device, so that scratching, deposition and contamination on the surface of the substrate caused during polishing of the substrate or handling can be prevented from becoming a problem, by forming a transparent, flat layer on the outer surface of the substrate before the condenser lenses.

### Fourth Embodiment

The fourth embodiment is a transflective liquid crystal display device for a portable apparatus manufactured in accordance with the manufacturing method of the second embodiment. FIG. 2 is a schematic diagram showing the outer appearance of a transflective liquid crystal display device for a portable apparatus manufactured in accordance with the manufacturing method of the second embodiment as viewed from the top, and FIG. 3 is a cross sectional diagram along A-A′ in FIG. 2. FIG. 4 is a schematic diagram showing an enlargement of the effective display region 201 in FIG. 2, FIG. 10 is a cross sectional diagram along B-B′ in FIG. 4, and FIG. 6 is an exploded perspective diagram. The liquid crystal display device according to the second embodiment of the present invention is described below in reference to these drawings.

The liquid crystal display device of the present embodiment has approximately the same configuration as the third embodiment, except in the flat layer. Here, mainly the flat layer in the liquid crystal display device according to the present embodiment is described.

Unlike in the case of the third embodiment, the flat layer is made by providing a transparent, flat film formed of two layers: an adhesive layer 511 for adhesion to the TFT substrate 507, and a base 512. The index of refraction of the adhesive layer 511 and the base 512 is 1.5, and the total thickness of the base 512 and the adhesive layer 511 in the transparent, flat film is 50 μm. In addition, the transmittance of the transparent, flat film for visible light (having a wavelength of 400 nm to 800 nm) is 95% or more and 100% or less when pasted to the TFT substrate 507.

The adhesive layer 511 is formed in order to bury the recesses and protrusions on the TFT substrate, and therefore, in the case where there is a great difference in the index of refraction between the substrate and the adhesive layer, light scatters when passing through the interface between the two. Therefore, it is desirable for there to be little difference in the index of refraction between the substrate and the adhesive layer. Non-alkali glass is used for the substrate of general liquid crystal display devices, and the index of refraction thereof is approximately 1.5. Therefore, it is desirable for the index of refraction of the adhesive layer to be 1.3 to 1.7. In addition, it is preferable for there to be little difference in the index of refraction between the base and the adhesive layer in the transparent, flat film, and it is better for there to be little optical anisotropy.

When a liquid crystal display device is assembled, light from the backlight transmits through the base 512 and the adhesive layer 511 in the transparent, flat film, and therefore, there is loss of light in the base 512 and the adhesive layer 511 in the transparent, flat film if the transmittance is low. In addition, the color reproducibility of the liquid crystal display device becomes poor in the case where the base 512 and the adhesive layer 511 in the transparent, flat film are colored. Therefore, the higher the transmittance of the base 512 and the adhesive layer 511 in the transparent, flat film is for visible light, the better, and it is desirable for the transmittance to be 95% or higher.

In addition, though the transparent, flat film has a two-layer structure, it may have more than two layers, or a one-layer structure of a viscous layer cured using light or heat.

The liquid crystal display device of the present embodiment is designed so that the distance between the condenser lenses and the transmissive apertures, which are light transmitting portions in the TFT substrate, is 150 μm, and therefore, the total thickness is 150 μm, which is the sum of the thickness of the TFT substrate (100 μm) and the total thickness of the base and the adhesive layer in the transparent, flat film (50 μm), which matches the design.

As described above, the polarizing film contracts when heated, and therefore, the pitch of the condenser lenses changes, as a result of the thermal contraction of the polarizing film, after condenser lenses are formed on the polarizing film. However, a transparent, flat film which does not easily thermally expand or shrink is selected for the present embodiment, and thus, the pitch of the lenses changes less due to heat, in comparison with the case where the condenser lenses are formed on a polarizing film.

As described above, the present structure allows for a uniform surface when the lenses are formed, and therefore, a liquid crystal display device where light from the backlight can be effectively used can be gained with high precision and high yield at low cost.

In the liquid crystal display device of the present embodiment, recesses and protrusions on the surface of the TFT substrate 507 are buried in the adhesive layer 511 in the transparent, flat film, and therefore, stable condenser lenses 509 can be formed on the surface of the base 512 of the transparent, flat film, so that the condenser lenses 509 can appropriately condense light from the backlight module 510.

Though in the present embodiment, a liquid crystal display device for a portable apparatus is described, the present embodiment can be applied to transmissive liquid crystal display devices having no reflective display portion 404, as well as to liquid crystal panels for applications other than portable apparatuses, such as televisions and car navigation. In addition, the present embodiment can be applied to various liquid crystal devices, for example to TN (twisted nematic) devices, IPS (in-place switching) devices, or VA (vertical alignment) devices. In the case of other devices, the configuration of the elements, the form of the elements and the materials may be completely different. However, whatever the type of device, the effects of the structure of the present embodiment can be gained for any device, so that scratching, deposition and contamination on the surface of the substrate caused during polishing of the substrate or handling can be prevented from becoming a problem, by forming a transparent, flat layer on the outer surface of the substrate before the condenser lenses.

### INDUSTRIAL APPLICABILITY

The present invention makes it possible to form stable condenser lenses by forming a transparent, flat layer, even in the case where the surface of the liquid crystal panel substrate has depressions or deposit resulting from polishing, or is scratched or contaminated with organic substances before the formation of condenser lenses. Furthermore, a uniform surface can be provided simply by forming a transparent, flat layer, even in liquid crystal panels where wet cleaning or surface polishing is difficult after a polarizing film is provided or a driver IC mounted. In addition, the layer thickness of the transparent, flat layer can be adjusted, and thus, it is possible to control the length of the optical path.

What is claimed is:

1. A method for a liquid crystal display device comprising:
an illumination apparatus for emitting light;
a first substrate provided on said illumination apparatus side, a second substrate provided on the viewer side, and a liquid crystal panel having a liquid crystal layer provided between said first substrate and said second substrate; and
a number of condenser lenses provided between said illumination apparatus and said liquid crystal panel, wherein
the manufacturing method for a liquid crystal display device is characterized by comprising the steps of:
forming a transparent, flat layer on an outer surface of said first substrate before forming said condenser lenses; and
forming said number of condenser lenses on said transparent, flat layer.

2. The manufacturing method for a liquid crystal display device according to claim 1, characterized by further comprising the step of polishing at least an outer surface of said first substrate before forming a transparent, flat layer on the outer surface of said first substrate.

3. The manufacturing method for a liquid crystal display device according to claim 1, characterized in that said transparent, flat layer has such properties that the transmittance of light in the visible light region is 95% or more and 100% or less.

4. The manufacturing method for a liquid crystal display device according to claim 1, characterized in that said transparent, flat layer has an index of refraction of 1.3 or more and 1.7 or less.

5. The manufacturing method for a liquid crystal display device according to claim 1, characterized in that said transparent, flat layer has a thickness of 0.01 μm or more and 100 μm or less.

6. The manufacturing method for a liquid crystal display device according to claim 1, characterized in that a thermocurable or photocurable resin layer is formed as said transparent, flat layer.

7. The manufacturing method for a liquid crystal display device according to claim 1, characterized in that said transparent, flat layer is formed by pasting a film on the outer surface of the first substrate.

8. The manufacturing method for a liquid crystal display device according to claim 1, characterized in that said condenser lenses are formed through offset printing.

9. A liquid crystal display device, comprising:
an illumination apparatus for emitting light;
a first substrate provided on said illumination apparatus side, a second substrate provided on the viewer side, and a liquid crystal panel having a liquid crystal layer provided between said first substrate and said second substrate; and
a number of condenser lenses provided between said illumination apparatus and said liquid crystal panel, wherein
the liquid crystal display device is characterized by further comprising:
a transparent, flat layer provided on the outer surface of said first substrate, and
said number of condenser lenses on said transparent, flat layer.

10. The liquid crystal display device according to claim 9, characterized in that said transparent, flat layer has such properties that the transmittance of light in the visible light region is 95% or more and 100% or less.

11. The liquid crystal display device according to claim 9, characterized in that said transparent, flat layer has an index of refraction of 1.3 or more and 1.7 or less.

12. The liquid crystal display device according to claim 9, characterized in that said transparent, flat layer has a thickness of 0.01 μm or more and 100 μm or less.

13. The liquid crystal display device according to claim 9, characterized in that said transparent, flat layer is a thermocurable or photocurable resin layer.

14. The liquid crystal display device according to claim 9, characterized in that said transparent, flat layer is a transparent film.

15. The liquid crystal display device according to claim 9, characterized in that said transparent, flat layer is formed by applying a material on the outer surface of the first substrate.

16. The manufacturing method for a liquid crystal display device according to claim 1, characterized in that said transparent, flat layer is formed by applying a material on the outer surface of the first substrate.
